(19) United States
(12) Patent Application Publication
(10) Pub. No.: US 2010/0246476 A1
(43) Pub. Date: Sep. 30, 2010

(54) METHOD FOR DRIVING SMART ANTENNAS IN A COMMUNICATION NETWORK

(76) Inventors: Serge Hethuin, Courbevoie (FR); Adrien Duprez, Paris (FR)

Correspondence Address: STROOCK & STROOCK & LAVAN LLP, 180 MAIDEN LANE, NEW YORK, NY, 10038, US

(21) Appl. No.: 12/681,744

(22) PCT Filed: Oct. 2, 2008
(86) PCT No.: PCT/EP08/63252

§ 371 Date: Apr. 5, 2010

(30) Foreign Application Priority Data
Oct. 5, 2007 (FR) 0707009

(51) Int. Cl. H04B 7/14; H04W 56/00

(52) U.S. Cl. 370/315; 370/328

(57) ABSTRACT

A method and device for implementing a smart antenna in a network that uses a deterministic access protocol, one or more mobile stations MS and at least one base station BS, the transmitted data being included in a data frame, wherein it comprises at least the following steps: On entry into the network:
the step of synchronizing a mobile station MS equipped with an FESA directional antenna on a transmission from the base station by changing beam for a duration at least equal to a frame in order to aim the directional beam toward the base station BS to obtain the best signal reception,
the step of following the synchronization of the mobile station on the transmission from the base station, and implementing an aiming tracking algorithm in order to retain the best signal reception,
the step of determining the parameters for defining the downlink or the uplink by decoding signaling messages contained in the message transmitted by the base station,
triggering a network entry procedure.
   Once the mobile station MS has entered the network:
the selection of the new beam being based on a mechanism with hysteresis that uses a linear filtering preceded by a hop-based rejection step or that directly uses a nonlinear filter.

### FIELD OF THE INVENTION

The invention relates notably to the steering of smart antennas, hereinafter called FESA or Fast Electronically Steerable Antennas. These so-called smart antennas are characterized by a highly directional lobe which can be oriented in a given direction in a very short time (a few hundred nanoseconds). They are used, for example, in vehicle, boat and aircraft-type mobiles for which the implementation of directional lobe antennas with dynamic aiming is vitally important.

The implementation of such antennas for fixed points can also represent an advantage, in order to do away with manual aiming for example.

The present invention also relates to a method that makes it possible to use the smart antennas in a wireless communication system.

### BACKGROUND OF THE INVENTION

In recent years, significant progress has been made in the field of antennas in order to improve the link budget and their range. The prior art describes various techniques with which to address this demand.

By virtue of the channel modulation and coding techniques, the communication bit rates have significantly increased through the progress made on the density of transmitted information. For example, modulation and demodulation techniques make it possible to transport 6 bits per modulation symbol (64 QAM in WiMAX mode). Research on channel coding has been very fruitful, for example in turbocodes. These error correcting codes make it possible to converge much more closely on the Shannon limit. However, in his theory of information, Shannon shows that the radiofrequency RF signal strength and bandwidth establish an upper limit at the capacity of a communication link:

C=B*log2(1+S/N),

with C=channel capacity (bits/s), B=channel bandwidth (Hz), S=signal strength (watts), N=noise power (watts)

There are also, in certain types of application (notably LOS: Line Of Sight), techniques that make it possible to accurately position directional aerials. The placement of these aerials is mainly manual, even assisted by radio strength measuring tools or geo-positioning tools (GPS, or Global Positioning System).

This approach is tedious, static and costly. Even when motorized, the aiming of the antennas is a costly and not very fast procedure.

There are also relaying techniques. Some protocols allow for the call to be relayed when a direct route is not practicable (route does not exist for lack of range or the presence of an obstacle, traffic congestion). However, any relaying notably involves:
either a loss of bandwidth and an increase in latency (single-radio mode),
or maintained bandwidth and latency at the cost of two radios (and not just one).

In order to improve the bit rates, various antenna processing techniques have also been developed, some of which are reviewed hereinbelow.

### STC Diversity

In the field of radio transmissions, the diversity techniques are often used to counter the phenomenon of multiple-path propagation causing fading of the transmitted signal.

Antenna diversity (several antennas sending and/or receiving)—called space diversity—is the most commonly used. The concept of space diversity is as follows: in the presence of random fading due to multiple-path propagation, the signal-to-noise ratio is significantly improved by combining the signals received on the decorrelated elements of the antenna.

There are also:
time diversity which relies on transmission of the same signal over two different channels but with a slight time offset,
frequency, arrival angle or polarization diversity, diversity by combining multiple paths based on the spread spectrum principle,
space-time coding diversity, used in the MIMO (Multiple Input Multiple

Output) techniques.

### MIMO (Multiple Input Multiple Output)

MIMO exploits the diversity of electromagnetic paths in an environment rich in multiple paths to increase the bit rates. MIMO is not effective in LOS mode (because no multiple paths).

### Electromagnetic Beamforming, or Simply Beamforming (Analog/Digital)

The beamforming technique consists in forming an electromagnetic beam in a given direction from transmissions, weighted in phase and in amplitude, from several antennas. The standard IEEE 802.16 uses the term AAS (Adaptive Antenna System) to designate the beamforming technology. The term “Smart Antenna”, with the same meaning, is also used in the literature. The standard 802.16e concentrates (for reasons of equipment costs for the subscriber), as much as possible, the intelligence and complexity at the base station level. However, to improve the performance of the AAS, 802.16e defines additional messages/procedures between the base station BS and the mobile station MS.

The comparative gains of N-channel beamforming with a conventional antenna are:
for the uplink direction: 10*log(N) (BF gain)
for the downlink direction: 20*log(N) (BF gain and addition of the powers of each antenna).

Electromagnetic beamforming also offers lower susceptibility to potentially interfering external transmissions. Some beamforming algorithms can even do better than emphasize the received gain in a given direction by creating “zeros” in the received pattern, that is to say, set a minimum gain in the direction of the interference. While powerful, this technique does, however, present some drawbacks. The circuits or hardware for handling the beamforming function are bulky in as much as they require several radio subsystems.

### Directional Antenna Steering Techniques

The directional antenna steering techniques developed hitherto target beam switching times of the order of a second, or even of around a hundred milliseconds. These techniques implement scanning and integration procedures over a period that is relatively long and therefore suitable for obtaining signal statistics and they are therefore incompatible with fast servocontrol techniques.

The antenna processing techniques include limits. Beamforming and MIMO require several transmit/receive channels, which can make them bulky and costly. The benefit of MIMO is conditional on the environment in which it is used. The increase in bit rate that is allowed is directly proportional to the number of antennas that must be spaced apart by a few wavelengths.

Another line of development has been in new antennas. Among the latter, there are smart antennas, called FESA, standing for Fast Electronically Steerable Antenna, which are characterized by: a very high gain, a bulk that is significantly less than that of the beamforming (and MIMO) technique, ultra-short switching times. Such antenna have no more than partial and non-omnidirectional angular coverage in normal or nominal operation.

### SUMMARY OF THE INVENTION

The object of the invention notably relates to a method that makes it possible to steer, at each instant, the direction of this beam (from an FESA antenna), by taking into account the mobility of the various stations involved in the communication, the energy management (sleep/idle mode) and critical network entry and call transfer between cells, or “handover”, phases.

Hereinafter, it is assumed that an FESA antenna can be diagrammatically represented and behave as a directional beam that can be aimed by an N-bit bus, these N (8 for example) bits defining a direction of the central axis of the antenna in a 2D plane of the type: b=k * 360/(2^{N}) with: b being the direction of aiming relative to a reference position, 2^{N} being the possible number of positions over 360°, and K being the value of the N-bit bus.

The subject of the invention addresses, notably, the procedures for implementing FESA antennas on terminals (subscriber, user, base station, etc.) in, for example, a mobile WiMAX (War/a/wide Interoperability for Microwave Access) context, in order, notably:
to be able to define applicable procedures in a mobile WiMAX context without compromising the standard defined above, or any other equivalent context,
to make the duly modified terminals compatible with the existing base stations; there are no modifications to be made to the base stations.

The subject of the present invention relates to a method for implementing an FESA directional smart antenna in a network that uses a deterministic access protocol, one or more mobile stations MS and at least one base station BS, the transmitted data being included in a data frame, characterized in that it comprises at least the following steps:
on entry into the network:
the step of synchronizing a mobile station MS equipped with an FESA directional antenna on a transmission from the base station by changing beam for a duration at least equal to a data frame in order to aim the directional beam toward the base station BS to obtain the best signal reception,
the step of following up the synchronization of the mobile station on the transmission from the base station, and implementing an aiming tracking algorithm in order to retain the best signal reception,
the step of determining the parameters for defining the downlink or the uplink by decoding signaling messages contained in the message transmitted by the base station,
triggering a network entry procedure.

Once the mobile station MS has entered the network:
the selection of the new beam being based on a mechanism with hysteresis that uses a linear filtering preceded by a hop-based rejection step or that directly uses a nonlinear filter.

The synchronization step is, for example, carried out with an FESA antenna configured in omnidirectional coverage mode and positioned on the mobile station MS side if the signal is sufficient.

The synchronization follow-up step includes an aiming tracking step, after the mobile station synchronization step, the beam being directed in successive or adjacent directions within the frame and from frame to frame in order to retain the optimum direction at all times.

The invention also relates to a device for steering an FESA smart antenna in a communication network that comprises a network interface, an MAC access layer, an energy interface and a radio module, characterized in that the MAC access layer comprises an FESA steering module in conjunction with with the FESA antenna, a radio steering module.

### BRIEF DESCRIPTION OF THE DRAWINGS

Other features and benefits of the present invention will become more apparent from reading the following description of an exemplary embodiment, given by way of illustration and in a nonlimiting manner, with appended figures which represent:

FIG. 1, an example of different configurations of reception from the base station by the mobile station,

FIG. 2, a representation of a few possible beams from the FESA antenna,

FIG. 3, a representation of an FESA antenna steering block diagram,

FIG. 4, a PMP (point-to-multipoint) link topology,

FIGS. 5, 6 and 7, respectively for a mobile station equipped with an FESA antenna, the best antenna gain of the FESA antenna compared to an omnidirectional pattern, the search for the best beam direction and the respective antenna lobes of a base station on the one hand and of a mobile station equipped with an FESA antenna on the other hand,

FIG. 8, the hardware block diagram of a mobile station equipped with an FESA antenna,

FIG. 9, an approach based on decreasing beam widths (respectively, increasing antenna gains),

FIG. 10, a representation of the antenna lobes of the base station equipped with an omnidirectional antenna and of the mobile station equipped with an FESA antenna,

FIG. 11, a representation of the different radio coverage positions of the base station equipped with an antenna operating in beamforming mode in the case of a mobile station equipped with an FESA antenna,

FIG. 12, the result of a process anticipating a switch in the main aiming direction,

FIG. 13, a diagram of a base station equipped with an FESA antenna and an omnidirectional antenna,

FIG. 14, an 802.16 network comprising relay stations RS,

FIG. 15, successive beams of the FESA in a relay station, the base station and the mobile station being omnidirectional, and

FIG. 16, successive beams from the FESA in a base station BS, relay station RS and mobile station MS.

### DETAILED DESCRIPTION OF THE PREFERRED EMBODIMENTS

In order to better understand the principle implemented by the inventive method, the following description is given in the case of a WiMax network, in an illustrative and by no means limiting manner. The procedures described within the context of this patent are defined for an 802.16 system, but can be generally applied to any system based on a deterministic access protocol.

The proposed solution for FESA procedures implements, for example, the following principles:
use of an 802.16d/e civilian base,
production of each node, corresponding to a mobile station, from market-standard 802.16 hardware (ASIC—Application-Specific Integrated Circuit-type hardware components, PHY layer and software modules),
a mobile station equipped with an FESA-type antenna must be able to operate with a base station BS, equipped or not with the adaptive antenna system AAS,
the nodes (base station BS, relay station RS or mobile station MS) provided with an FESA capability are incorporated in a WiMAX (Worldwide Interoperability for Microwave Access) network with no impact on the other nodes of the network,
the time slots that are useless for transmission are used to ascertain the transmission direction (useful for entry into the network, tracking and calls between cells or “handovers”).

The inventive method notably resolves the following problems:
entry into the network of a mobile station, which leads:
to synchronization with the base station,
to the decoding of the management messages,
to the network entry procedures (authorization, ranging, etc.),
the tracking of the base station BS (according to the mobility of the station MS),
all of the operations implemented making it possible for a mobile station to be able to change cell without any service interruption, or “handover”,
“sleep/idle” mode.

The first exemplary implementation of the inventive method relates to a mobile station equipped with an FESA-type antenna in a PMP network, in other words in a network in which the links are point-to-multipoint links.

The base station involved in the network can be either not equipped with the automatic adaptation system, or non-AAS, or be equipped with an adaptive antenna system, as defined in the 802.16d/e standard.

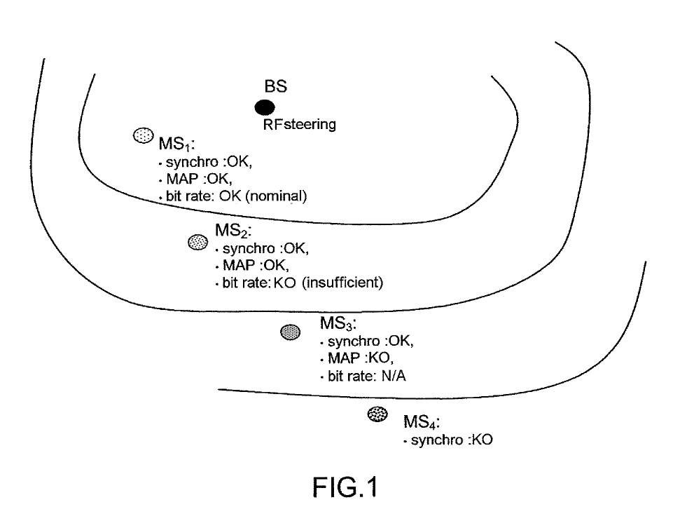

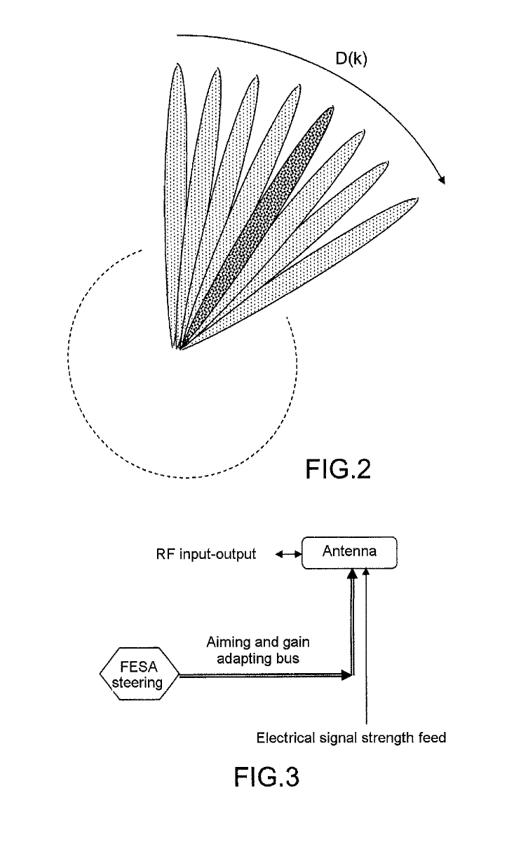

FIG. 1 represents different configurations for reception from a base station by the mobile station. For a mobile station equipped with an FESA station, of which some of the beams transmitted by the latter are represented in FIG. 2, where D(k) corresponds to the different beam aiming values, the mobile stations MS1 and MS2 (FIG. 1) see an improvement in the signal-to-noise ratio SNR, and therefore an increase in the bit rate (transition to more effective modulations) for MS1 and a possibility to transmit at a minimum bit rate (accessible minimum modulation) for MS2. The mobile stations MS3 see the possibility of decoding the DL-MAP signaling messages from the station and mobile stations MS4 see the possibility of being synchronized (the stations MS4 cannot be synchronized if they are not equipped with an FESA antenna).

FIG. 2 diagrammatically represents a number of beams transmitted by the FESA antenna in a given aiming direction. The direction of the beams transmitted varies with the index k.

FIG. 3 diagrammatically represents an example of steering of an FESA antenna. The implementation can be based, for example, on two means described hereinbelow.

A first technique consists in using a parallel bus. The resulting benefit is speed of control. The aiming direction and the antenna gain are applied without delay as soon as the information changes on the parallel bus. On the other hand, this parallel bus requires a cable with as many conductors as there are bits defined in the bus.

The second technique relies on a serial link which offers the benefit of minimizing the number of conductors of the control bus between the radio modem and the antenna: one conductor for the information and one conductor for the charging signal. The drawback then lies in the architecture of the circuits required (serial-parallel register) in the antenna for storing the information on triggering the charging signal but also on the delay to be granted between the sending of the command and the actual application of the parameters.

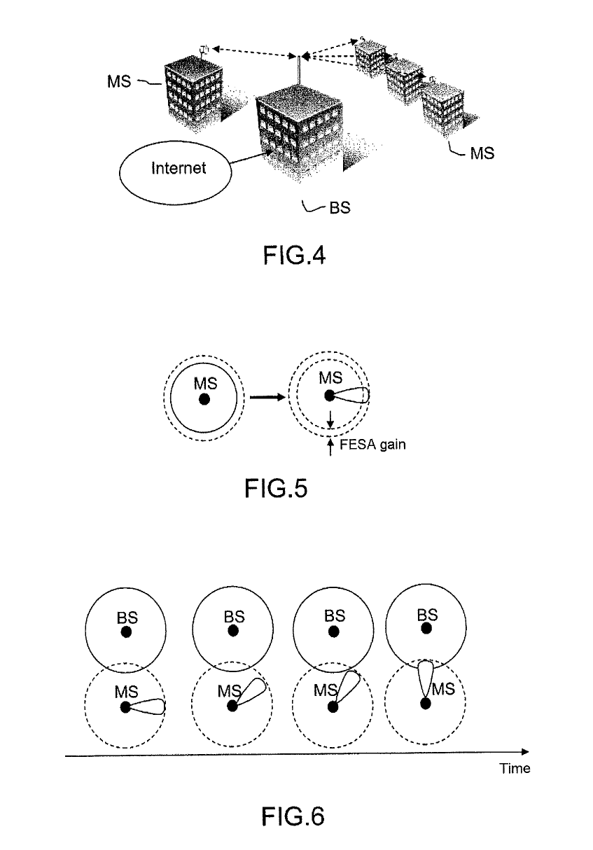

FIG. 4 represents an exemplary topology for point-to-multipoint links comprising a base station BS and several mobile stations MS equipped with an FESA antenna, which intercommunicate by applying the inventive procedure, the communication relying, for example, on the Internet.

FIG. 5 represents the increase in the antenna gain and the associated reduction of the antenna lobe provided by the use of an FESA antenna on a mobile station in this example. The case of a base station equipped with an FESA antenna is described below. FIG. 6 represents, in a time axis, a mobile station MS equipped with an FESA antenna searching for the best network.

Since the mobile station MS is equipped with at least one FESA-type antenna, the latter offers the advantage of facilitating the synchronization of the mobile station MS on the transmission from the base station (downlink procedure) by extension of the antenna gain.

The steps implemented by the method are, for example, as follows: the energy is concentrated in a narrow beam transmitted by the FESA antenna and the downlink subframe is considered;

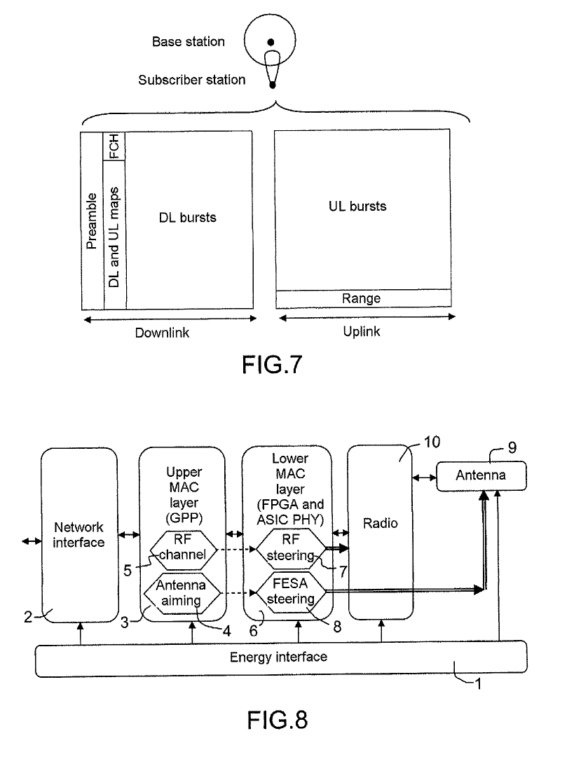

Initialization of the subscriber mobile station, search for a base station:
The method searches for the best beam (directional beam from the MS which looks for the energy from the BS) by changing the aiming of the beam on each frame (maximum size frame by default), until the beam is aimed toward the base station (or in the direction providing the best signal reception from the base station). FIG. 6 represents this step for searching for the best aiming of the electromagnetic beam in a mobile station. A processor forming part of the device (see FIG. 8) makes it possible to vary the angle of transmission of the beam from the FESA antenna of the mobile station when it is searching for a base station BS.
FIG. 7 represents the overlap of the omnidirectional antenna lobes of the base station 85 and of the beam of a mobile station equipped with an FESA antenna thus allowing communication between the two. The associated OFDMA frame structure, for the downlink and for the uplink, is also represented. Advantageously, the antenna gain which is thus available on the MS makes it possible to improve the link budget and therefore the bit rate, or else, given the same signal-to-noise ratio, it makes it possible to start a connection process with greater ranges.
The mobile station MS having found the base station with which it can dialog, the next step is the step for synchronization of the mobile station MS on the transmission from the base station. This corresponds to attaching the “downlink preamble”. The synchronization step is performed according to the principles known to those skilled in the art.
The parameters defining the downlink are then obtained by decoding signaling messages (messages FCH which describes the composition of the frame, DL-MAP, an MAC 802.16 message which describes the allocation of the bandwidth, and IDCD, downlink channel descriptor relating to the description of the radio channel).
The method then implements, for example, a conventional 802.16 procedure, that is to say, entry into the network.
If the entry into the network fails (e.g. “foreign” network), the transmission angle of the beam is varied and the steps previously described are repeated until synchronization, the obtaining of the downlink definition parameters and the network entry procedure.

FIG. 8 shows a possible hardware diagram for a mobile station MS equipped with an FESA in the case of the 802.16 protocol. The MAC layer controls the direction of the antenna by selecting a beam.

This figure shows: an energy interface 1 powering various elements, a network interface 2, linked with the upper layer 3 or upper Mac layer, which comprises means 4 for steering the aiming of the antenna and the elements 5 of the radiofrequency channel in which the various elements work. The antenna aiming function is, for example, carried out by means of a processor that makes it possible notably to execute various calculations, for example averages, or other types of calculation, some of which will be given hereinbelow.

The lower layer 6 is linked with the lower medium access control layer, or lower MAC, which comprises radiofrequency steering means 7 and the steering device 8 for the FESA antenna, the latter being directly linked with the antenna 9. At the lower layer level, FPGA (Field-Programmable Gate Arrays), or even integrated circuits or A SICs (Application-Specific Integrated Circuits) are used, making it possible notably to execute real-time functions such as sequencing of the antenna, etc. A radio layer 10 linked with the FESA antenna 9.

Since the initialization and network entry procedure is finished, the method can pursue the tracking phase.

### Tracking

The purpose of tracking is to ensure that the selected beam from the FESA antenna of the mobile station MS for communication with the base station is at all times directed optimally.

To achieve this result, the tracking algorithm measures meaningful parameters for a number of directions around the nominal direction according to a time constant during which the signal is integrated, the results obtained are compared and the direction tracked is decided according to a processing operation making it possible notably to overcome any problems of variation in the power of the momentary transmission.

The FESA antennas can operate either with radio nodes equipped with a GPS by using the available GPS information, or with radio nodes that are totally unequipped therewith.

### With GPS

In the case where GPS information is available (sender and receiver coordinates), then the node or mobile station equipped with an FESA antenna can determine the theoretical best direction and align itself thereon. Once positioned, a procedure takes various measurements to check that the theoretical best direction for the antenna beam is also the best in practice. To check that the best direction has been found, the following steps are, for example, executed: a first confirmation that the connection can be made, then a test of the direction and, possibly, of the directly adjacent directions in the downlink periods of the broadcast channel (downlink broadcast) from the base station 85 with an average over several frames on one position if necessary. The function for calculating the average is located in the upper MAC layer.

### Without GPS

Without GPS, the beam from the FESA antenna is positioned on a default direction (e.g., the last used if the synchronization process is still active); this information is stored in the upper MAC layer. Then, the direction of the beam changes according to the tracking algorithm.

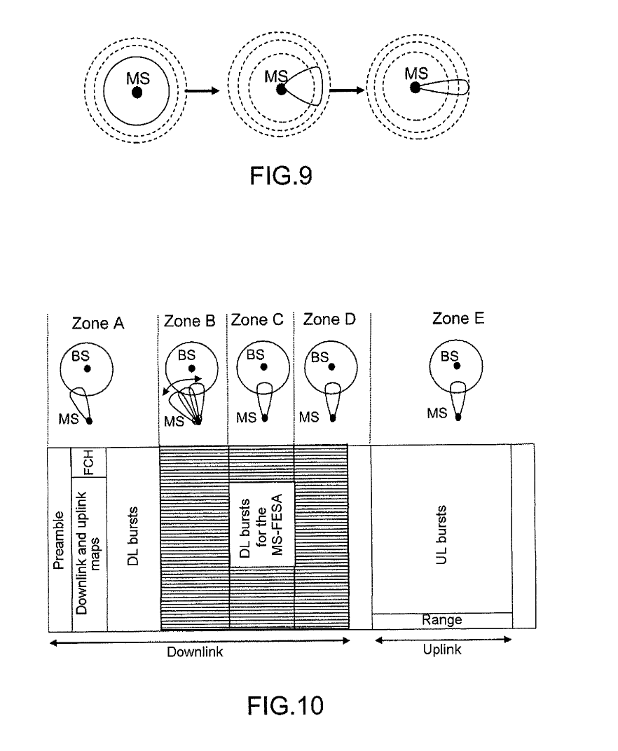

A complementary approach consists in varying the width of the beam transmitted by the FESA antenna, incrementally, as is represented in FIG. 9. To take account of the mobility applications leading to faster beam changes, the beam can be widened at the end of each frame, then narrowed by tracking at the start of the next frame (provided that the signal-to-noise ratio SNR is sufficient). The refining for the best beam can also be done in the downlink subframe, when the BS is not addressing the MS-FESA. This is represented in FIG. 10.

If the mobile MS is close to the BS, the aiming variations can be rapid and aiming tracking can become difficult. The lobe widths (antenna gains) will therefore be kept moderate, especially as the short distance between BS and MS means that the link budget is sufficient with an omnidirectional pattern. Conversely, if the mobile is moving away from the BS, then it can become advantageous to increase the antenna gain by narrowing the beam and supporting the increase in distance between BS and MS by virtue of the directivity of the FESA antenna. Beam width and aiming of the beam are two different parameters that are managed in a complementary manner.

In the example of FIG. 10, the MS-FESA has its beam badly adjusted relative to the BS. This is due to the mobility. However, the MS-FESA succeeds (see zone A) in being synchronized and in decoding the downlink parameters (FCH, DL-MAP and MD messages).

In zone A, still, the BS broadcasts information to all the subscriber stations. In zone B, the MS-FESA concerned knows, by virtue of the FCH or DL-MAP message, that it has a predetermined time without having to pick up dedicated information from the BS. It exploits this time to narrow its beam to the BS. This narrowing can be terminated at the end of the zone B, as is the case in FIG. 10. Otherwise, it could interrupt this narrowing in the zone C and resume it in zone D.

A hysteresis mechanism is, for example, implemented to stabilize the system, and thus avoid excessively fast switchings between two beam directions.

### Details Concerning the Optimal Aiming Tracking Algorithm:

Hereinafter, an approach based on linear filtering of the α-β type possibly preceded by a nonlinear rejection algorithm is described. The same approach could be made by using Kalman-type filtering.

Hereinafter, we will consider energy (RSSI) or SNR measurements carried out on 3 contiguous aiming directions with a given directivity (antenna gain or lobe width): nominal direction k and adjacent directions k−1 and k+1.

The RSSI or SNR measurements in the direction k during the time within a frame or over several frames at regular instants (the same approach can be described with irregular sampling instants but the formulation is much more difficult) are mₖ(nT). Similarly, in the direction (k−1) at the instants nT+Tₖ₋₁, the measurements are: mₖ₋₁(nT+Tₖ₋₁). Similarly, the measurements in the direction (k+1) at the instants nT+Tₖ₊₁ are: mₖ₊₁(nT+Tₖ₊₁). nT represents the measurement instants in the direction k, whereas nT+Tₖ₋₁ and nT+Tₖ₊₁ represent the measurement instants in the respective directions k−1 and k+1 (Tₖ₋₁ and Tₖ₊₁ are offsets relative to the instants nT).

In the direction k, the method uses the following filter:

MPₖ(nT)=Mₖ(nT−T)+vₖ(nT−T)*T

eₖ(nT)≈mₖ(nT)−MPₖ(nT)

Mₖ(nT)=MPₖ(nT)+αeₖ(nT)

vₖ(nT)=vₖ(nT−T)+βeₖ(nT)/T
with:
MP: prediction for the instant t
e: error between measurement and prediction at the instant T
M: estimation at the instant T
v: estimated speed of change

In the direction k−1, the following filter is applied:

MPₖ₋₁(nT+Tₖ₋₁)=Mₖ₋₁(nT+Tₖ₋₁−T)+vₖ₋₁(nT+Tₖ₋₁−T)*T

eₖ₋₁(nT+Tₖ₋₁).≈mₖ₋₁(nT+Tₖ₋₁)−MPₖ₋₁(nT+Tₖ₋₁)

M_{k—1}(nT+Tₖ₋₁)=MPₖ₋₁(nT+Tₖ₋₁)+αeₖ₋₁(nT+Tₖ₋₁)

vₖ₋₁(nT+Tₖ₋₁)=vₖ₋₁(nT+Tₖ₋₁−T)+βeₖ₋₁(nT+Tₖ₋₁)/T

In the direction k+1, the following filter is applied:

MPₖ₊₁(nT+Tₖ₊₁)=Mₖ₊₁(nT+Tₖ₊₁−T)+vₖ₊₁(nT+Tₖ₊₁−T)*T

eₖ₊₁(nT+Tₖ₊₁)≈mₖ₊₁(nT+Tₖ₊₁)−MPₖ₊₁(nT+Tₖ₊₁)

Mₖ₊₁(nT+Tₖ₊₁)=MPₖ₊₁(nT+Tₖ₊₁)+αeₖ₊₁(nT+Tₖ₊₁)

vₖ₊₁(nT+Tₖ₊₁)=vₖ₊₁(nT+Tₖ₊₁−T)+βeₖ₊₁(nT+Tₖ₊₁)/T

Hysteresis consists in comparing, at each instant nT+delta (delta being the upper bound of Tₖ₋₁ and Tₖ₊₁) the value of Mₖ(nT) with Mₖ₋₁(nT+Tₖ₋₁) and Mₖ₊₁(nT+Tₖ₊₁). If the value of Mₖ(nT) is always greater than X1 dB at Mₖ₋₁(nT+Tₖ₋₁) and than Mₖ₊₁(nT+Tₖ₊₁), then the value of k is retained as optimal aiming. If one of the values Mₖ₋₁(nT+Tₖ₋₁) or Mₖ₊₁(nT+Tₖ₊₁) is greater than X2 dB relative to Mₖ(nT), then the corresponding direction is taken as the optimal aiming direction.

The predictions MP make it possible to know and anticipate a switch in the main aiming direction. In practice, the speeds of change make it possible to calculate in advance from the direction of k−1 or of k+1 which of the two will take over. Since the general trend is of the type described in relation to FIG. 12, in which the deviation between the directions k and k−1 works in favor of the latter.

If a radio is out of range or in “sleep/idle” mode, then, in the absence of GPS-type information, the beam on resumption is the last one used or a phase for acquiring the best aiming angle recommences.

If a radio is in “idle” mode, then, in the absence of GPS-type information that indicates to it which is the closest BS, on each periodic meeting with the “paging” group (defined on entering into “idle” mode as described by the WiMAX standard), the beam that is resumed is the last one used but preceded by a 360° scan to confirm the best direction to the best BS. This scan can be carried out a few instants before (in the preceding frames) the periodic meeting with the paging group.

### Meaningful Parameters for the Tracking Algorithm

The tracking algorithm implemented by the method can be based on the least squares method, known to those skilled in the art, but also on techniques such as that mentioned above based on α-β linear filtering with estimation of the average aiming and of the speed of change of the aiming direction followed by a nonlinear rejection algorithm for the instantaneous measurements that are too far apart. A number of criteria can be taken into account, such as the power statistics (received power, signal-to-noise ratio if available) or the channel coding statistics.

As an example, the method considers two tracking algorithms:

### Example A

### Received Power Optimization Criterion

The power criterion is the simplest to use (measuring the RSSI, standing for Received Signal Strength Indication). It is indirectly linked to the robustness of the communication.

The mobile station MS exploits times in the downlink subframe in which no burst is intended for it, that is to say that it receives no dedicated information from the base station, to measure the received signal strengths on the other directions of the beam from its FESA antenna. In practical terms, for several beam aiming angle values, it determines a received signal strength or energy, then it can calculate the average of all the signal strength values.

The calculations are, for example, carried out in the antenna aiming device situated in the upper Mac layer.

These measurements are valid in as much as the base station BS is transmitting at the measured instants, that is to say that the BS is interested in the other MSs. It delivers their respective messages to them, the MS concerned having nothing in particular to receive during these instants. This is checked by the mobile station MS in the FCH (Frame Control Header) message and the DL-MAP message mapping the downlink. The selected direction is, for example, the one for which the average received signal strength is maximum.

The detailed algorithm procedure, considering the aiming of the FESA antenna of the mobile station MS obtained on the preceding frame N−1 and the omnidirectional pattern on the antenna of the BS, is, for example, as follows:
synchronization of the mobile station MS on the base station BS by using the synchronization steps described previously,
reading by the mobile station MS of the FCH and DL-MAP messages to ascertain the downlink access structure,
in the downlink burst phase of the sequence A, adaptation of the aiming of the beam from the MS to the BS (omni-constant pattern) by a method of measuring the signal strength by taking into account or not taking into account the channel statistics. Since the base station addresses other mobile stations MS than the one trying to lock on, the time for which the base station does not address an FESA mobile station is exploited by this mobile station MS-FESA to refine, by calculations carried out, for example, on the steering device, the aiming of its beam to the BS. A number of mobile stations MS-FESA can narrow their beam at the same time (omnipattern on the BS).

### Example B

### Combination of Signal Strength and Signal/Noise Ratio or SNR

The SNR value is an excellent criterion because it is directly linked to the demodulation capability. However, it assumes that the mobile station MS demodulates symbols. This therefore means that the WiMAX MS is modified to also demodulate symbols that are not intended for it, and do so in order to determine the SNR therefrom. The symbols acquired by the mobile station are decoded in order to retrieve the modulated data then determine the value of the signal-to-noise ratio by executing statistical methods known to those skilled in the art. This method can be longer than the previous one because it entails waiting for the duration of a symbol. This method can be coupled with the use of the channel coding statistics.

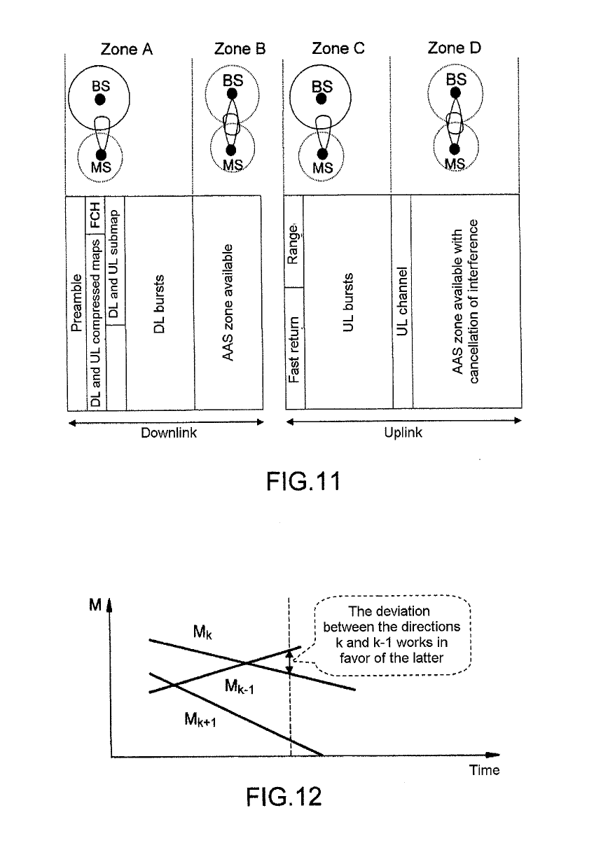

The algorithm-based procedure implemented can be as follows, by considering the aiming of the FESA antenna on the MS obtained on the preceding frame and the omnidirectional pattern on the antenna of the BS, is as follows:
synchronization of the MS on the BS,
reading by the MS of the FCH and DL-MAP messages to ascertain the downlink access structure,
in the downlink burst phase of the sequence A (B in FIG. 11), adaptation of the aiming of the beam from the MS to the BS (with constant omnipattern) by a method of measuring the signal strength and the SNR with the channel statistics taken into account or not. With the BS addressing other MSs, the time for which it does not address an MS is exploited by that MS to refine the pointing of its beam to that BS. Several MSs can refine their beam at the same time (omnipattern on the BS).

### Handover

In the standard 802.16e, the two main types of handover are defined as follows:
Abrupt cell changeover mechanism, or “hard handover”: the MS stops its radio link with the first BS before setting up a radio link with the next.
Soft cell changeover mechanism, or “soft handover”: this handover is much faster than the hard handover, in as much as the communication is not cut. The MS sets up the link with the next BS before breaking the preceding link.

The two types of soft handover defined in 802.16e are:
Fast BS Switching (FBSS): this handover is rapid in as much as there is no complete entry procedure to be performed with the new BS.
Macro Diversity HandOver (MDHO).

The mobile WiMAX profiles demand only the “hard handover”. FBSS and MDHO are optional. The handover must be carried out within a time of approximately 100 ms. In the soft handover context, the FESA antenna steering is used to search for a better BS. The signaling and possibly synchronization of the BSs between them, knowledge of the idle times, that is to say the times during which the station is neither receiving nor transmitting, give time to search for signal strength in the different azimuths to other BSs than the current BS. This knowledge of the surrounding energy sources is integrated in the search for a better base station for the soft handover.

### “Sleep/Idle” Mode

If a radio is in “sleep/idle” mode, then, in the absence of GPS-type information, the beam resumed at the end of the “sleep/idle” phase is the last one used or a phase for acquisition of the best aiming angle recommences.

If a radio is in “idle” mode, then, in the absence of GPS-type information that indicates to it the closest BS, on each periodic meeting with the paging group (defined on entry into “idle” mode as described by the WiMAX standard), the beam resumed is the last one used but complemented with a 360° scan to confirm the best direction to the best 135. This scan can be performed a few instants before (in the preceding frames) the periodic meeting with the paging group.

### FESA on Base Station BS

According to one embodiment, an FESA antenna is used on a base station and the steps of the method described hereinabove are applied. In the single-beam FESA antenna versions, this amounts to providing a base station with beamforming with a single beam. As in beamforming, the BS-FESA adapts the direction of its beam to its correspondent during the contention slots.

The nominal aiming approach consists in very rapidly scanning with a beam of minimum aperture (maximum antenna gain) all the azimuth positions.

For the BS-FESA, a complementary approach based on decreasing beam width is proposed, similar to that described in FIG. 9.

This approach based on adaptive width of the beam (adaptability in antenna gain) is proposed here on the BS. In this case, the maximum aperture (omnidirectional pattern) is assigned at the start of the frame during the low bit rate signaling phase, then the width of the lobe is narrowed to allow for a higher bit rate during the frame, subject to correctly aiming simultaneously to the as and to the subscriber concerned (for example with a procedure of the type: division by 2 of the width of the lobe followed by an optimization of the aiming direction, division by 2 of the antenna lobe and new optimization of the aiming direction, etc.). The procedure is therefore complementary and nested with the aiming procedure.

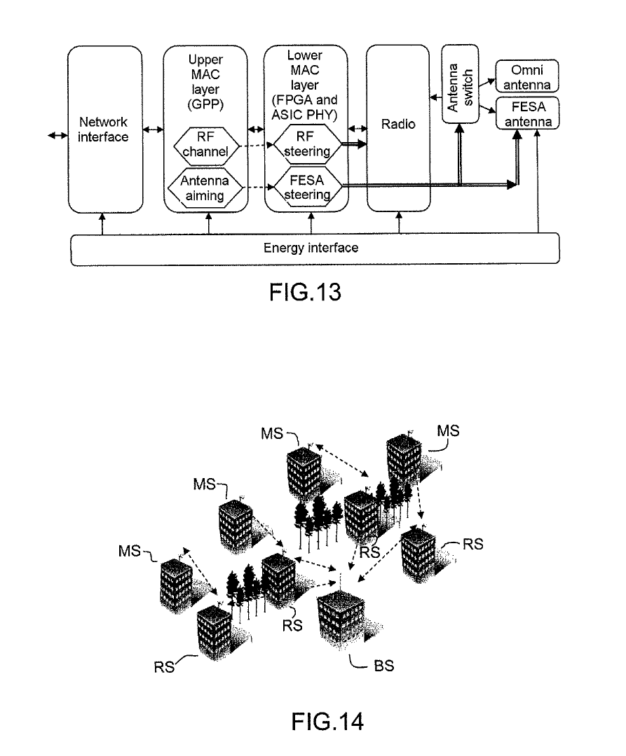

In the case where an FESA antenna is not capable of being configured as a directional or omnidirectional beam, then it is possible to add to it an omnidirectional antenna. In this case, the steering device of the FESA antenna controls an omniantenna/FESA antenna selection switch as represented in FIG. 13.

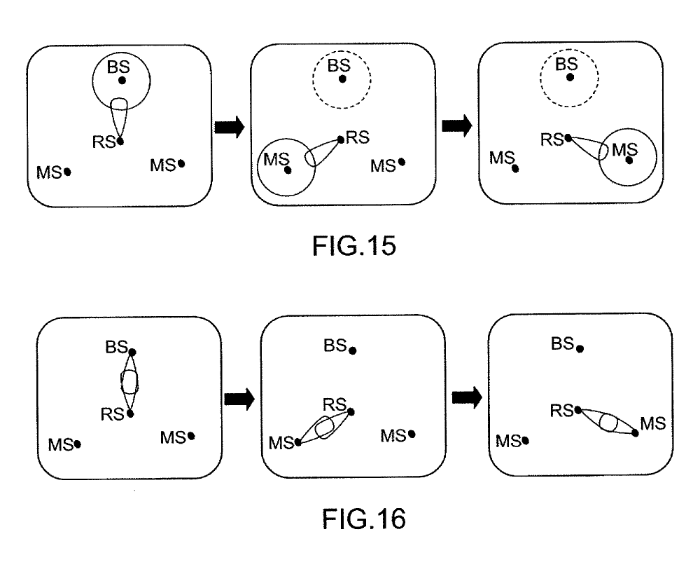

FIGS. 14, 15 and 16 describe the case of use of relay stations. 802.16j introduces relay stations (RS) alongside the BSs in the infrastructure. The purpose of these RSs is to extend the range of the base stations.

The mechanism for steering the FESA antenna in a relay station RS is similar to that of a BS-FESA in that the RS, unlike an MS, communicates with several stations within one and the same frame.

In practice, a relay station RS always communicates:
on the one hand with a higher order station, i.e., the base station BS or an RS which relays it to the BS,
on the other hand, with the mobile stations for which it relays the communications.

Furthermore, the periodic search for the best possible topology means that the RSs consider the communications from all azimuths. The FESA mechanism in an RS must therefore include this topology discovery functionality.

On each frame, given the possible mobility of all the nodes of the network, the RS, like the BS and the MSs, widens the width of the beam or refines the direction of the beam for all the necessary positions.

The addition of a GPS-type locating system makes it possible to enrich the antenna steering algorithm.

FIG. 16 diagrammatically represents the FESA procedures with GPS. The GPS can be used as an aid to the FESA procedures, in as much as the radio propagation may be different from that deduced from a GPS (e.g.: obstacles).

1. A method for implementing a smart antenna in a network that uses a deterministic access protocol, one or more mobile stations MS and at least one base station BS, the transmitted data being included in a data frame, the method comprising:
On entry into the network:
synchronizing a mobile station MS equipped with a fast electronically steerable antenna FESA directional antenna on a transmission from the base station by changing beam for a duration at least equal to a frame in order to aim the directional beam toward the base station BS to obtain the best signal reception,
following up the synchronization of the mobile station on the transmission from the base station, and implementing an aiming tracking algorithm in order to retain the best signal reception,
determining the parameters for defining the downlink or the uplink by decoding signaling messages contained in the message transmitted by the base station,
triggering a network entry procedure.
Once the mobile station MS has entered the network:
the selection of selecting the new beam being based on a mechanism with hysteresis that uses a linear filtering preceded by a hop-based rejection step or that directly uses a nonlinear filter.

2. The method as claimed in claim 1, wherein the synchronization step is carried out with an FESA antenna configured in omnidirectional coverage mode and positioned on the mobile station MS side if the signal is sufficient.

3. The method as claimed in claim 1, wherein the synchronization follow-up step includes an aiming tracking step, after the mobile station synchronization step, the beam being directed in successive or adjacent directions within the frame and from frame to frame in order to retain the optimum direction at all times.

4. The method as claimed in claim 1, wherein GPS-type information is used in order to determine the best position.

5. The method as claimed in claim 1, wherein, without GPS, the beam is positioned at the outset on a default direction and wherein a search mechanism finds the most likely direction, then wherein the direction of the beam changes according to a tracking algorithm consisting in permanently following the best direction.

6. The method as claimed in claim 5, wherein the beam is widened at each end of frame, then narrowed by tracking at the start of the next frame.

7. The method as claimed in claim 1, wherein the filter is a Kalman filter.

8. The method as claimed in claim 1, further comprising a tracking step comprising a hysteresis mechanism that uses a linear filtering preceded by a nonlinear rejection algorithm.

9. The method as claimed in claim 7, further comprising a tracking step comprising a hysteresis mechanism that uses a linear filtering preceded by a nonlinear rejection algorithm.

10. The method as claimed in claim 1, wherein the tracking algorithm, adapting the aiming of the beam from the MS to the base station, uses a method of measuring the power or that takes account of the channel coding statistics.

11. The method as claimed in claim 1, wherein the tracking algorithm uses a method of measuring the power and the signal-to-noise ratio SNR.

12. The method as claimed in claim 1, wherein the entry procedure is compatible with the standards 802.16, 802.16d or 802.16e.

13. The method as claimed in claim 1, wherein the procedure for tracking the direction of aiming toward a BS is also used to search for the aiming directions toward the adjacent BSs and for facilitating the handover step.

14. The method as claimed in claim 1, wherein the base station BS is equipped with an FESA antenna and/or one or more relay stations RS are equipped with an FESA antenna.

15. The method as claimed in claim 1, wherein the communication network is a point-to-multipoint link-type network.

16. A device for steering a fast electronically steerable antenna FESA smart antenna in a communication network that comprises a network interface, a media accessible layer MAC access layer, an energy interface and a radio module, wherein the MAC access layer comprises an FESA steering module in conjunction with the FESA antenna, a radio steering module, and in that said FESA steering module and said radio steering module are designed to execute the steps of the method as claimed in claim 1.
